(19) United States
(12) Patent Application Publication
(10) Pub. No.: US 2024/0101321 A1
(43) Pub. Date: Mar. 28, 2024

(54) CONTAINER SYSTEM AND METHOD

(71) Applicant: Ring Container Technologies LLC, Oakland, TN (US)

(72) Inventors: David Alan Anderson, Aurora, IL (US); Paul Vincent Kelley, Arlington, TN (US)

(73) Assignee: Ring Container Technologies LLC, Oakland, TN (US)

(21) Appl. No.: 17/950,365

(22) Filed: Sep. 22, 2022

(51) Int. Cl. B65D 51/16; B29C 49/42; B65D 1/02; B65D 43/02; B65D 53/04

(52) U.S. Cl. CPC B65D 51/1688; B29C 49/4278; B65D 1/0246; B65D 43/0231; B65D 53/04; B29L 2031/7158; B65D 2543/00537

(57) ABSTRACT

A packaging container is provided. The packaging container includes a body defining a volume. The body includes a neck extending from an opening of the body, and a base. A substrate is engageable with the neck to form a seal. The substrate defines at least one opening. A closure includes a projection engageable with the substrate. The projection defines at least one gap. In some embodiments, container systems and methods of manufacturing containers are disclosed.

### TECHNICAL FIELD

The present disclosure generally relates to packaging containers and more particularly to plastic containers capable of high fill temperatures and pasteurization, and methods for making the same for food packaging.

### BACKGROUND

Plastic blow-molded containers are commonly used for food packaging products. Many food and beverage products are sold to the consuming public in blow-molded containers. These containers can be made from polyethylene terephythalate or other suitable plastic resins in a range of sizes. The empty blow-molded containers can be filled with food and/or beverage products at a fill site utilizing automated fill equipment.

For example, manufacture of such plastic blow-molded containers can include initially forming plastic resin into a preform, which may be provided by injection molding. Typically, the preform includes a mouth and a generally tubular body that terminates in a closed end. Prior to being formed into containers, preforms are softened and transferred into a mold cavity configured in the shape of a selected container. In the mold cavity, the preforms are blow-molded or stretch blow-molded and expanded into the selected container.

These food packaging containers are adapted to store food packaging products, however, during manufacturing and depending on the type of food being stored in the container, the container may need to be vented. For example, a container can be vented as a safety feature so that gas from an inside of the container is released into the atmosphere prior to a lid being removed from the container. A container can also be vented to facilitate the escape of steam from the inside of the container and into the atmosphere when the container is filled with a hot product during manufacture. This disclosure describes an improvement over these prior technologies.

### SUMMARY

In one embodiment, a packaging container includes a body defining a volume. The body includes a neck extending from an opening of the body, and a base. A substrate is engageable with the neck to form a seal. The substrate defines at least one opening. A closure includes a projection engageable with the substrate. The projection defines at least one gap. In some embodiments, container systems and methods of manufacturing containers are disclosed.

In one embodiment, a blow molded packaging container is provided. The blow molded packaging container includes a body defining a volume. The body includes a neck extending from an opening of the body, and a base. A liner is engageable with the neck to form a seal. The liner defines at least one vent. A closure includes a seal engageable with the liner, and the seal defines at least one relief.

In one embodiment, a method for manufacturing a packaging container is provided. The method comprising the steps of: blow molding an article having a selected configuration including a body defining a volume, a neck and a dome; trimming the article to remove the dome to form a finished container; attaching a substrate to the neck, the substrate defining at least one opening; and attaching a closure to the neck, the closure including a projection engageable with the substrate. The projection defining at least one gap.

In one embodiment, a blow molded packaging container is provided. The blow molded packaging container includes a body defining a volume. The body includes a base, and a neck extending from an opening of the body. A liner is engageable with the neck to form a seal. The liner defines at least one vent, and a closure is engageable with the liner.

### BRIEF DESCRIPTION OF THE DRAWINGS

The present disclosure will become more readily apparent from the specific description accompanied by the following drawings, in which:

FIG. 1 is a side view of one embodiment of a container system in accordance with the principles of the present disclosure;

FIG. 2 is a plan view of components of the container system shown in FIG. 1;

FIG. 3 is an enlarged side view of components of the container system shown in FIG. 1;

FIG. 4 is a break away perspective view of components of one embodiment of a container system in accordance with the principles of the present disclosure;

FIG. 5 is a break away perspective view of components of one embodiment of a container system in accordance with the principles of the present disclosure;

FIG. 6 is a plan view of components of the container system shown in FIG. 1;

FIG. 7 is a plan view of components of the container system shown in FIG. 1;

FIG. 8 is a plan view of components of the container system shown in FIG. 1;

FIG. 9 is a perspective view of one embodiment of components of a container system in accordance with the principles of the present disclosure;

FIG. 10 is a side view of components of the container system shown in FIG. 9;

FIG. 11 is a plan view of components of the container system shown in FIG. 9; and

FIG. 12 is a perspective view of one embodiment of a container system in accordance with the principles of the present disclosure.

### DETAILED DESCRIPTION

The exemplary embodiments of blow-molded containers and more particularly, polyethylene terephythalate (PET) containers and methods for making the same are discussed in terms of food packaging products. In some embodiments, the present container includes a liner defining at least one vent, and a closure that includes a seal engageable with the liner defining at least one relief for products that require a breathable container.

In some embodiments, the present container is configured for vacuum, gas, and/or vapor permeation. In some embodiments, vacuum, gas, and/or vapor permeation is facilitated via at least one outlet, for example, at least one opening. In some embodiments, the at least one opening includes at least one vent. In some embodiments, the container is vented via a liner and a closure such that selected dry foods and/or consumer products packaged warm can be vented after filling. In some embodiments, the container is vented so that as warm dry food or consumer products cool, pressure changes in the container can be normalized from inside the container to an outside environment to prevent the container from deforming or paneling. In some embodiments, venting the container normalizes the internal pressure of the container to prevent container failure and/or container deformation. In some embodiments, the container is vented a selected amount for container stability and venting does not affect freshness of the dry food or product.

In some embodiments, the present container includes a blow molded and trimmed container. In some embodiments, the container includes a vented closure and a vented liner. In some embodiments, venting via the closure enables trimmed and non-vented containers to be vented. In some embodiments, the closure includes a seal. In some embodiments, the seal includes at least one gap. In some embodiments, the at least one gap includes at least one relief configured to form a leak point in the seal. In some embodiments, the at least one relief contacts pressure points on the neck of the container and improves consistency of the seal such that the seal is maintained between a lip of the neck of the container and the closure. In some embodiments, a circumference of the seal includes 50% or less of the at least one relief. In some embodiments, a circumference of the seal includes 10% or less of the at least one relief. In some embodiments, the combination of a blow molded and trimmed container with a vented closure and a vented seal allows for a container having a neck opening diameter of 40 mm or more to be vented. In some embodiments, the combination of a blow molded and trimmed container with a vented closure and a vented seal allows for a container having a neck opening diameter of 63 mm or more to be vented. In some embodiments, the container is vented via a vented closure and a vented seal reducing container material.

In some embodiments, the present container includes a substrate that is configured for engagement with a neck of the container to form a seal. In some embodiments, the substrate includes a liner. In some embodiments, the liner includes at least one outlet, for example, at least one opening. In some embodiments, the at least one opening includes at least one vent. In some embodiments the liner includes vents including pin holes. In some embodiments, the liner includes three or more pin holes. In some embodiments, the liner includes a linear orientation of vents, including holes along a surface of the liner. In some embodiments, the liner includes vents that are centrally disposed on the surface of the liner. In some embodiments, the liner includes one or more layers. In some embodiments, the one or more layers include a heat seal layer, a foil layer and a backing layer. In some embodiments, the heat seal layer, the foil layer and the backing layer are pierced for maximum venting of the container. In some embodiments, the heat seal layer is oriented toward a container side and the backing layer is oriented toward a closure side. In some embodiments, an amount the container can vent is based on a combined area of the vents such that a higher combined area of vents, facilitates a greater amount of venting. In some embodiments, a vented liner and a vented closure enable a non-vented container to be implemented in the sector of injected neck containers.

In some embodiments, the present disclosure includes a container that is employed with a method for manufacturing food packaging having the ability to produce food packages made from PET with minimal weight and selectively desirable physical performance features, as described herein.

The present disclosure may be understood more readily by reference to the following detailed description of the embodiments taken in connection with the accompanying drawing figures, which form a part of this disclosure. It is to be understood that this application is not limited to the specific devices, methods, conditions or parameters described and/or shown herein, and that the terminology used herein is for the purpose of describing particular embodiments by way of example only and is not intended to be limiting. In some embodiments, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. It is also understood that all spatial references, such as, for example, horizontal, vertical, top, upper, lower, bottom, left and right, are for illustrative purposes only and can be varied within the scope of the disclosure. For example, the references “upper” and “lower” are relative and used only in the context to the other, and are not necessarily “superior” and “inferior”.

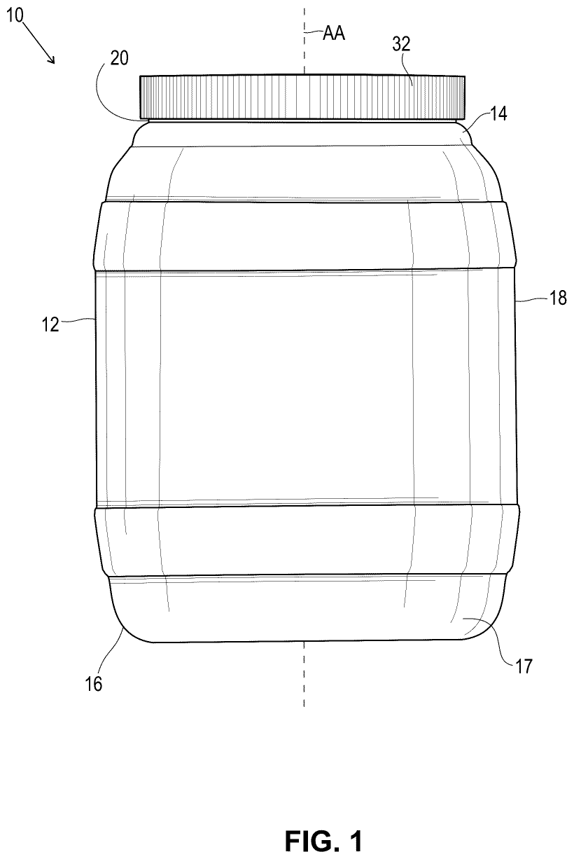

The following discussion includes a description of components of a blow molded container and methods of manufacturing a packaging container. Alternate embodiments are also disclosed. Reference is made in detail to the exemplary embodiments of the present disclosure, which are illustrated in the accompanying figures. Turning to FIGS. 1-11, there are illustrated components of a blow molded container 10.

Container 10 is configured for storing products such as food, food preparation, beverages and/or other consumer products including, but not limited to peanut butter, pretzels and/or cheeseballs. Container 10 includes a body 12 that extends from an end 14 to an end 16, and defines a longitudinal axis AA, as shown in FIG. 1. End 16 includes a base 17. Body 12 includes a circumferential side wall 18 that extends between ends 14, 16. A volume is defined from body 12. Body 12 includes a substantially cylindrical configuration. In some embodiments, body 12 may include various configurations, for example, oval, oblong, triangular, square, polygonal, irregular, uniform, non-uniform, offset, staggered, and/or tapered. Body 12 may be manufactured by blow molding techniques, as described herein. In some embodiments, body 12 includes one or a plurality of walls.

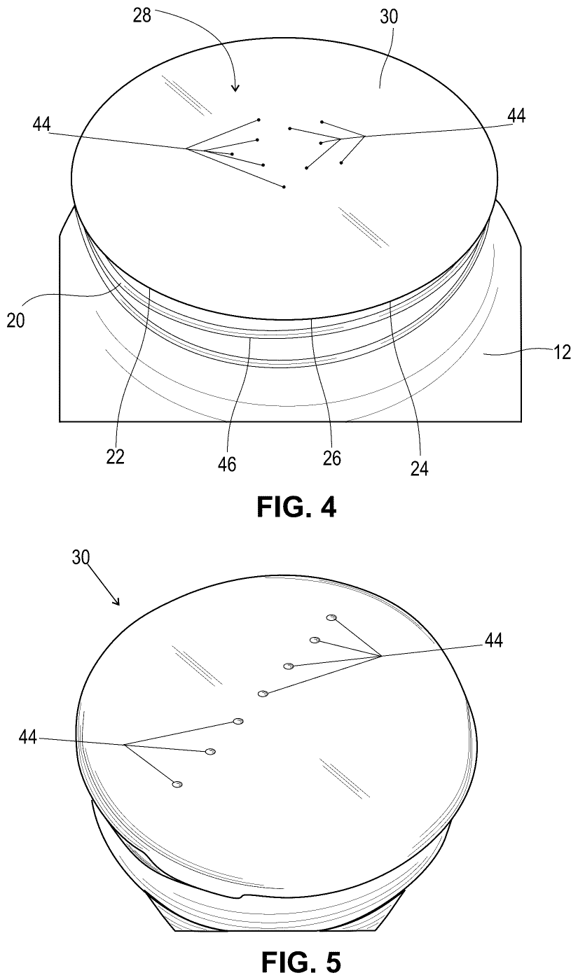

End 14 includes a surface that defines a neck 20, as shown in FIGS. 1 and 4. Neck 20 is centrally disposed relative to body 12 and includes a cylindrical neck configuration. In some embodiments, neck 20 may include various configurations, for example, oval, oblong, triangular, square, polygonal, irregular, uniform, non-uniform, offset, staggered, and/or tapered. In some embodiments, neck 20 can include various surface configurations including smooth, rough, textured, porous, semi-porous, dimpled, knurled, toothed, raised, grooved and/or polished.

Neck 20 includes a sealing surface 22 and a neck finish 24, as shown in FIG. 4. Sealing surface 22 includes a circumferential lip 26 extending from an opening 28 of neck 20. Sealing surface 22 is configured for sealing engagement with a substrate, for example, a liner 30 and a closure, for example, a lid 32, as described herein. In some embodiments, sealing surface 22 can include various surface configurations including smooth, rough, textured, porous, semi-porous, dimpled, knurled, toothed, raised, grooved and/or polished.

Liner 30 is engageable with sealing surface 22 to form a seal. In some embodiments, container 10 is hermetically sealed, including induction sealed. Liner 30 includes a heat sealed layer 34, a foil layer 36 and a backing layer 38, as shown in FIG. 3. Heat seal layer 34 is engageable with sealing surface 22 and backing layer 38 is engageable with lid 32. Liner 30 defines at least one opening 40, as shown in FIG. 3. A conical shaped cavity 42 is in communication with opening 40 to form at least one vent 44 in liner 30. In some embodiments, cavity 42 may include various configurations, for example, oval, oblong, triangular, square, polygonal, irregular, uniform, non-uniform, offset, staggered, and/or tapered.

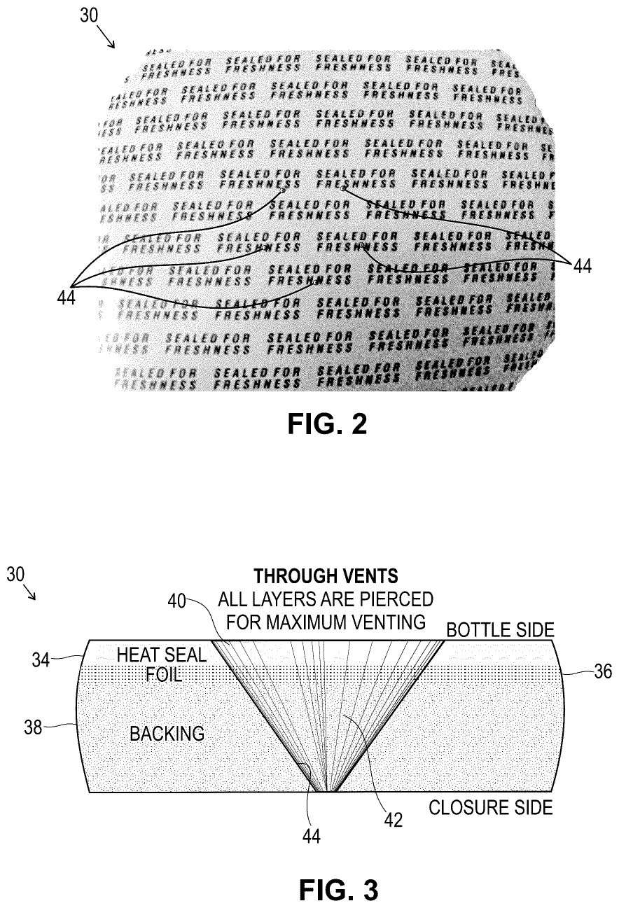

Vent 44 is configured for passage of a pressurized gas from an interior volume of body 12 to an exterior environment of container 10. In some embodiments, liner 30 includes a recessed surface including a vent hole. In some embodiments, liner 30 includes a plurality of vents 44, as shown in FIGS. 2, 4 and 5. In some embodiments, vents 44 are aligned in a linear orientation along liner 30, as shown in FIG. 5. In some embodiments, vents 44 are centrally disposed relative to liner 30, as shown in FIG. 4. In some embodiments, vents 44 are configured via mechanically punched holes in liner 30. In some embodiments, an amount container 10 can vent is based on a combined area of vents 44. In some embodiments, vents 44 include from 1 to 100 vents. In some embodiments, vents 44 include a diameter from 0.5 millimeters (mm) to 3 mm. In some embodiments, vents 44 may include various configurations, for example, oval, oblong, triangular, square, polygonal, irregular, uniform, non-uniform, offset, staggered, and/or tapered. In some embodiments, vents 44 may be formed in liner 30 via a laser and/or a mechanical tool.

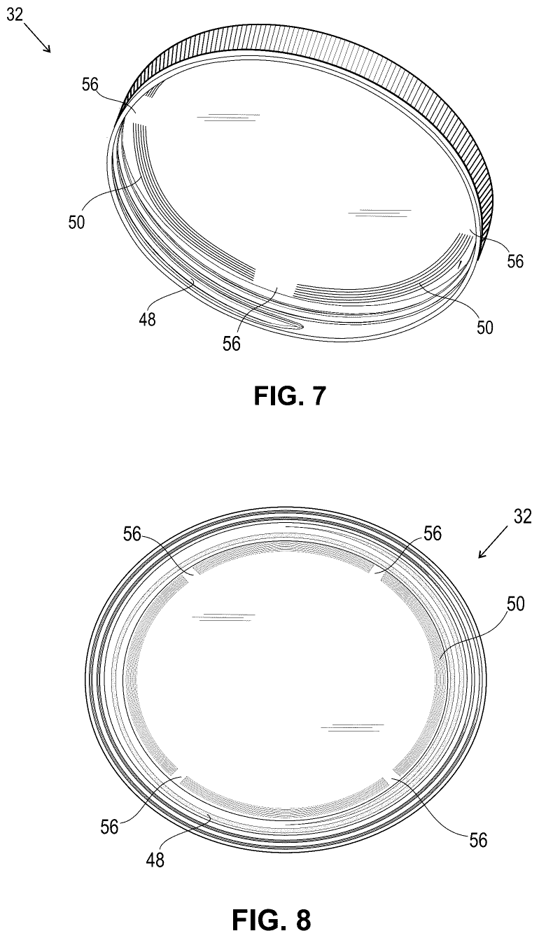

Lid 32 is engageable with neck 20, as shown in FIG. 1. Neck finish 24 includes a diameter, and at least one thread 46 is disposed about the diameter, as shown in FIG. 4. Thread 46 is configured for engagement with at least one thread 48 of lid 32, as shown in FIGS. 7 and 8. In some embodiments, thread 46 and/or thread 48 include a plurality of threads. In some embodiments, thread 46 and/or thread 48 may include various configurations, for example, non-angled, irregular, uniform, non-uniform, offset, staggered, and/or tapered.

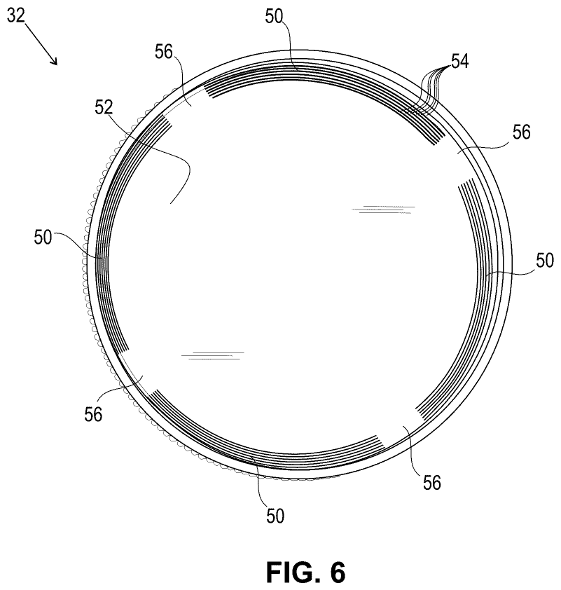

Lid 32 is engageable with liner 30. Lid 32 includes a projection, for example, a seal 50 shown in FIG. 6 that is engageable with liner 30. Seal 50 is disposed in a circumferential orientation about an inner wall surface 52 of lid 32. Seal 50 includes a plurality of ridges 54, as shown in FIG. 6. In some embodiments, ridges 54 can include various surface configurations including smooth, rough, textured, porous, semi-porous, dimpled, knurled, toothed, raised, grooved and/or polished.

Seal 50 defines at least one gap, for example, at least one relief 56 as shown in FIGS. 6-8. In some embodiments, seal 50 defines a plurality of reliefs 56. Reliefs 56 are configured for passage of a pressurized gas from the interior volume of body 12 to an exterior environment of container 10. Reliefs 56 are even and/or flush with inner wall surface 52 and ridges 54 have a greater height relative to reliefs 56. In some embodiments, reliefs 56 are configured to form a leak point in seal 50. In some embodiments, reliefs 56 target pressure points on neck 20 and improve consistency of seal 50 such that seal 50 is maintained between lip 26 and lid 32.

In some embodiments, reliefs 56 include 10% or less of the circumference of seal 50. In some embodiments, reliefs 56 include 50% or less of the circumference of seal 50. In some embodiments, reliefs 56 may include various configurations, for example, oval, oblong, triangular, square, rectangular, polygonal, irregular, uniform, non-uniform, offset, staggered, and/or tapered. In some embodiments, reliefs 56 may be disposed at alternate orientations, relative to seal 50, for example, parallel, transverse and/or angular orientations such as acute or obtuse, coaxial and/or may be offset or staggered. In some embodiments, reliefs 56 may be formed in lid 32 via a laser and/or a mechanical or molding tool. In some embodiments, liner 30 includes the plurality of vents 44 and lid 32 does not include seal 50 and/or at least one relief 56.

Container 10 is made from PET. In some embodiments, container 10 may be fabricated from plastic. In some embodiments, container 10 may be fabricated from polyester (PES), polyethylene (PE), high-density polyethylene (HDPE), polyvinyl chloride (PVC), polyvinylidene chloride (PVDC) (Saran), low-density polyethylene (LDPE), polypropylene (PP), polystyrene (PS), high impact polystyrene (HIPS), polyamides (PA) (Nylons), acrylonitrile butadiene styrene (ABS), polyethylene/acrylonitrile butadiene styrene (PE/ABS), polycarbonate (PC), polycarbonate/acrylonitrile butadiene styrene (PC/ABS), and/or polyurethanes (PU). In some embodiments, container 10, as described herein, can be fabricated from materials suitable for food packaging products. In some embodiments, such materials include synthetic polymers such as thermoplastics, semi-rigid and rigid materials, elastomers, fabric and/or their composites.

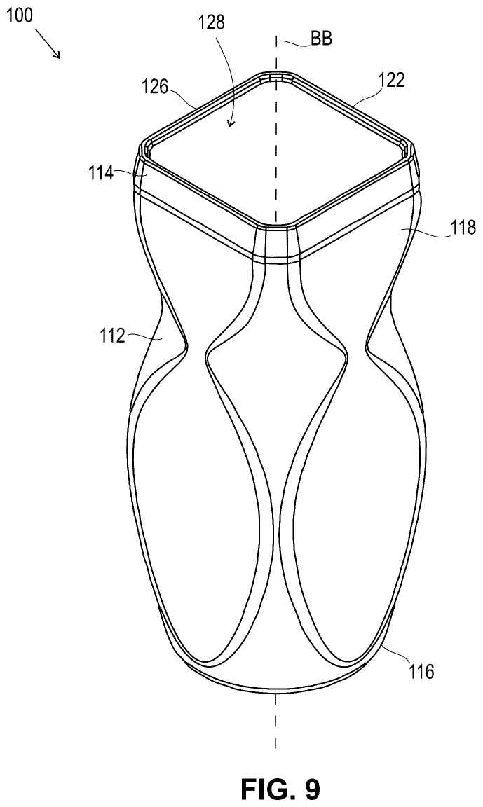

In some embodiments, a blow molded container 100, similar to container 10 is provided, as shown in FIGS. 9-11. Container 100 is configured for storing products such as food, food preparation, beverages and/or other consumer products including, but not limited to peanut butter, pretzels and/or cheeseballs. Container 100 includes a body 112 that extends from an end 114 to an end 116, and defines a longitudinal axis BB, as shown in FIG. 9. End 116 includes a base 117, as shown in FIG. 11. Body 112 includes a circumferential side wall 118 that extends between ends 114, 116. A volume is defined from body 112. Body 112 may be manufactured by blow molding techniques, as described herein.

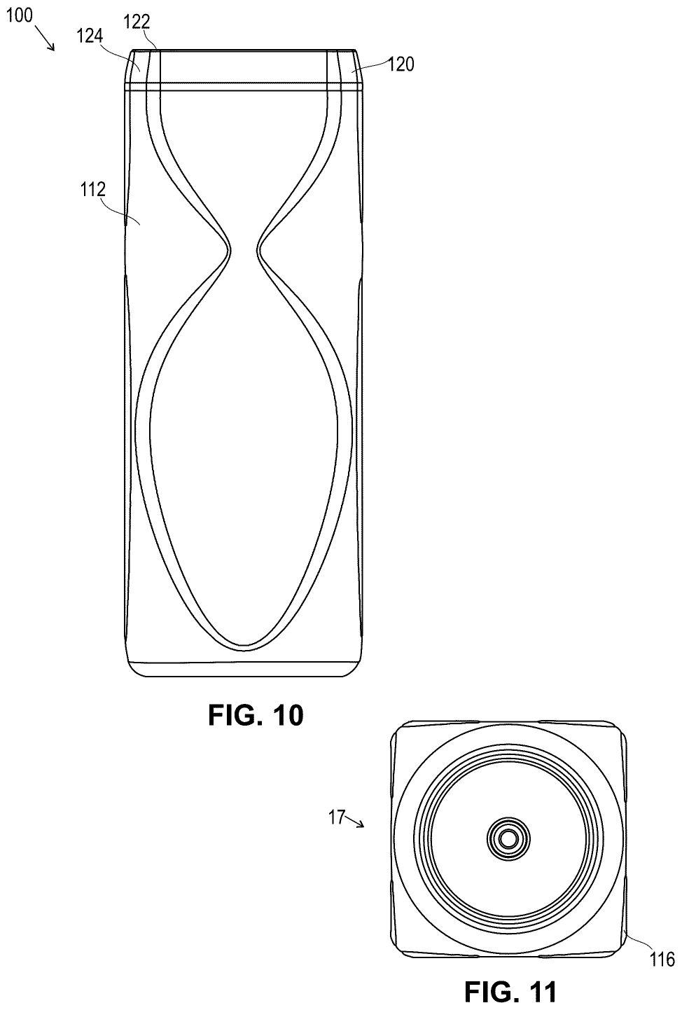

End 114 includes a surface that defines a neck 120, as shown in FIG. 10. Neck 120 is centrally disposed relative to body 112 and includes a cylindrical neck configuration. Neck 120 includes a sealing surface 122 and a neck finish 124, as shown in FIGS. 9 and 10. Sealing surface 122 includes a circumferential lip 126 extending from an opening 128 of neck 120. Sealing surface 122 is configured for sealing engagement with a substrate, for example, a liner (not shown), similar to liner 30 and a closure, for example, a lid (not shown), similar to lid 32, to vent container 100, as described herein.

A finished PET blow-molded, container 10 is manufactured for use with a selected application, as described herein. In some embodiments, the selected application includes food, food preparation oils, viscous and/or beverage products.

In some embodiments, a method for manufacturing container 10 and/or container 100 is provided. The method comprises the step of blow molding an article, for example, a preform (not shown), having a selected configuration having a body defining a volume, a neck and a dome. In some embodiments, during manufacturing, the preform is blow/molded in a blow molder (not shown). In some embodiments, the preform includes a selected configuration and is molded into an intermediate article, for example, an intermediate container (not shown) including the dome. In some embodiments, the method includes an HDPE intermediate container manufactured via an extruder instead of being molded from a preform. See also, for example, the embodiments and disclosure of a container and method for manufacturing a container, shown and described in commonly owned and assigned U.S. patent application Ser. No. 17/527,548 filed Nov. 16, 2021, and published as U.S. Patent Application Publication No. ------, on ---- --, ----, the entire contents of which being incorporated herein by reference.

In some embodiments, the method comprises the step of trimming the intermediate container to remove the dome to form a finished container. In some embodiments, the intermediate container will travel through a trimmer (not shown) to remove the dome. In some embodiments, after the dome is removed, the method comprises the step of filling container 10 and/or container 100 with food and/or beverage products at a fill site utilizing automated fill equipment, including, but not limited to an auger filling machine, a vibratory filler, a cup filler and/or a piston filler. In some embodiments, after container 10 and/or container 100 is filled, the method comprises the step of attaching a substrate, for example liner 30 to circumferential lip 26 of neck 20 and attaching a closure, for example, lid 32 to neck 20. In some embodiments, liner 30 is attached to circumferential lip 26 via induction sealing utilizing an induction sealing machine. In some embodiments, liner 30 is attached to circumferential lip 26 via conduction sealing utilizing a conduction sealing machine. The end product includes a finished container 10, shown in FIGS. 1-8 and/or finished container 100, shown in FIGS. 9-11 where vents 44 of liner 30 and reliefs 56 of lid 32 are configured for passage of a pressurized gas from an interior volume of body 12 and/or body 112 to an exterior environment of container 10 and/or container 100.

In some embodiments, methods of manufacturing, as described herein, can be employed with various types of plastic containers produced with a blown neck finish. In some embodiments, the method includes the step of reusing the dome to produce other containers. In some embodiments, the step of reusing the dome includes grinding, blending, drying and adding the dome and adding the ground, blended and dried material to a melt stream, wherein the dome does not contain additives.

In some embodiments, the food and/or beverage products are hot due to manufacturing and filling of the products. Positive pressure is induced in all directions inside container 10 and/or container 100 when container 10 and/or container 100 is filled with the food and/or beverage products and hermetically sealed. In some embodiments, container 10 and/or container 100 is capable of maintaining an initial shape at an elevated pressure of greater than 3 pounds per square inch (psi) and withstands a vacuum draw of greater than 3 In Hg during filling of container 10 and/or container 100 with hot food and/or beverage products.

Experiments:

Experiment 1: Performance Testing on a Container having a Vented Liner and a Vented Closure

Closure vents and a non-vented liner were induction sealed to containers 10. Results were observed in a dry vacuum chamber. Standard closures and vented closures were pressure tested in a dry vacuum chamber for seal integrity. Standard closures held their seal to a 15 in/hg value and the vented closures failed between 5-10 in/hg. Failure included blown liners or container paneling once the vacuum was removed. Containers including vented liners and vented closures (e.g., container 10 having liner 30 and lid 32) were pressure tested and no container paneling was shown indicating bottle internal volume and vacuum chamber were normalizing with no pressure differential during the test.

Experiment 2: Hermetic Seal Testing

In some food packaging embodiments, a hermetic seal is used to maintain product freshness and to provide tamper evidence for the product. In some embodiments, hermetic seals are achieved through conduction (direct heat) or induction (eddy current) methods on heat seal liners (e.g., liner 30). Induction sealing is the method used for this study.

In some embodiments, achieving a proper hermetic seal through induction sealing occurs when the combination of variables, including pressure, heat and time are administered to a package. Pressure can be derived by application torque of the closure (e.g., lid 32) being screwed onto the container (e.g., container 10), and is typically measured in in/lbs. Heat is created when the induction current is emitted onto the foil layer (e.g., foil layer 36) of the liner (liner 30). The induction current will heat up the sealant layer (e.g., heat sealed layer 34) of the liner that bonds to the container, thereby creating the seal. Time can be defined as the dwell time that the container is under the sealer where energy is applied to the container. There can be multiple combinations of the variables that produce a good seal since two variables can offset one lower variable. For example, if the application torque is low, increasing the time or heat administered to the container can compensate for low application torque.

For this test, the same sealing method described above was implemented for all sample sets. The parameters applied are listed below. The closure size was 110 mm in size and container volume was 1 gallon.
Parameters:
Pressure: Application Torque: 50 in/lbs
Heat: Sealer Energy Setting: 70%
Time: Time Under Sealer on Conveyor: ˜1 Second

Testing Methods: To test the viability of the containers, the containers were sealed using the same closures, sealing method and parameters. The only variable was the venting method, for example, the vented liner (e.g., liner 30) or vented closure (e.g., lid 32). Initial proof of concept testing includes sealing empty containers and using a vacuum chamber to test seal venting. Containers were observed for deformation and probes were used to quantify venting. Testing was moved to hot fill simulation testing. A hot fill simulation test includes heating two different baked products, for example, peanut butter pretzels and/or cheeseballs to their typical fill temperature, filling, sealing, and repeating the same visual testing and probe testing. It is understood that every product/package combination may require different venting amounts, so there is no set requirement for the vent testing. However, data and observations indicate reduced or no deformation and air movement over time.

Venting Methods:

Closure Venting: Many closures use a standing feature to concentrate the closing force of the torqued closure onto the bottle sealing surface. Without these features, the energy produced by an induction sealer can be dissipated across the entire heat seal liner, rather than focused on the bottle land. With the pressure concentrated where it needs to be, it facilitates the creation of a more robust seal. Creating a relief in the sealing feature of the closure creates a low or no pressure spot and thus reduces the seal strength in that area. For the prototypes, four reliefs were formed, each prototype including ⅛″ wide or roughly 3.5% of the circumference of the sealing surface.

Liner Venting: Liner venting comprises mechanically punching holes in the liner to create passageways for the container to vent. The depth (foil layer only or entire liner), number of vents (5, 10 or more) and size (diameter) vary by application. Some containers on the market rely on liner venting as the only method of venting, but it does require secondary tooling in the machine that cuts and places the liner in the closure during manufacturing.

Experiment 3: Optimization of Liner Venting by Product and Application

Heat, moisture content, and container strength all contribute to how much venting is needed for a container. Simulated filling experiments have been completed to obtain a base line on selected baked products. Having too many vent holes or venting too much can affect product freshness and having too little vent holes can cause container deformation or container failure.

Initial testing indicated that three pin holes through vents in the liner were sufficient during the simulated baking and sealing testing. Further, testing confirmed no paneling of the container after the product cooled. Data probe testing confirmed that the results were less than the market standard of a notched injected neck container. It is contemplated that 6 to 10 is comparable to notched injected neck containers.

Experiment 4: Liner Vent Hot Fill Simulation Testing

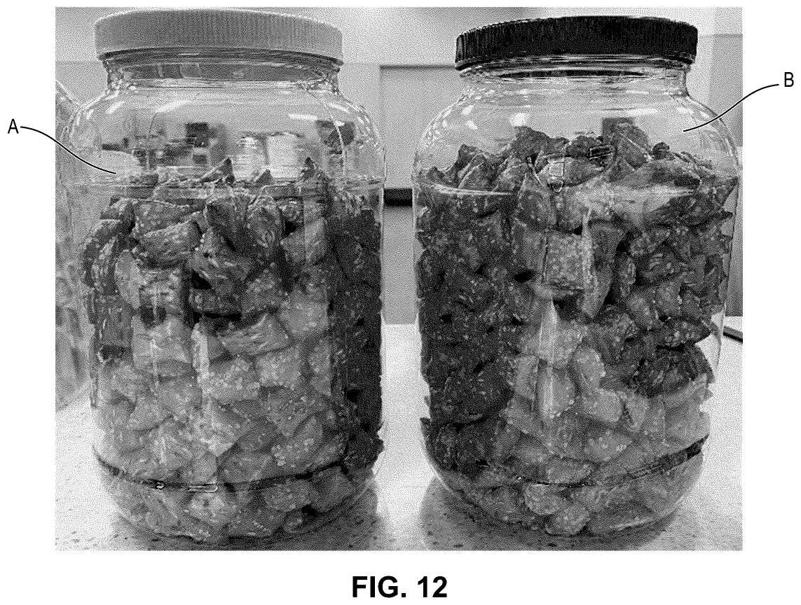

A product was heated, filled into containers A and B shown in FIG. 12, and was sealed to simulate fill conditions. Containers A and B (e.g., container 10) were observed for deformation or paneling which occurred if an interior of the container and exterior were not normalized through venting. Container A included a vented liner (e.g., liner 30) and container B included a non-vented liner. No paneling of the container was observed in container A and paneling of the container was observed in container B.

It will be understood that various modifications may be made to the embodiments disclosed herein. Therefore, the above description should not be construed as limiting, but merely as exemplification of the various embodiments. Those skilled in the art will envision other modifications within the scope and spirit of the claims appended hereto.

1. A packaging container comprising:
a body defining a volume, the body including a neck extending from an opening of the body, and a base;
a liner engageable with the neck to form a hermetic seal, the liner having a plurality of layers including at least a heat seal layer engageable with the neck and a backing layer engageable with a closure, the liner defining at least one opening extending through the layers; and
the closure including a projection engageable with the backing layer, the projection defining at least one gap.

2. A packaging container as recited in claim 1, wherein the at least one opening includes a conical shaped cavity extending through the plurality of layers to form a vent in communication with the volume.

3. A packaging container as recited in claim 2, wherein the vent is configured for passage of a pressurized gas from an interior volume of the container to an exterior environment of the container.

4. A packaging container as recited in claim 1, wherein the liner includes a recessed surface including a vent hole.

5. A packaging container as recited in claim 1, wherein the at least one opening includes a plurality of openings aligned in a linear orientation.

6. A packaging container as recited in claim 1, wherein the at least one opening includes a plurality of centrally disposed openings.

7. A packaging container as recited in claim 1, wherein the plurality of layers further includes a foil layer disposed between the heat seal layer and the backing layer.

8. A packaging container as recited in claim 1, wherein the projection is disposed in a circumferential orientation about an inner wall surface of the closure.

9. A packaging container as recited in claim 1, wherein the projection includes a plurality of ridges.

10. A packaging container as recited in claim 1, wherein the projection includes a plurality of gaps.

11. A packaging container as recited in claim 1, wherein the projection is disposed in a circumferential orientation about an inner wall surface of the closure and the at least one gap is 10% or less of the circumference.

12. A blow molded packaging container comprising:
a body defining a volume, the body including a neck extending from an opening of the body, and a base;
a liner engageable with the neck to form a hermetic seal, the liner having a plurality of layers including a heat seal layer engageable with the neck, a backing layer engageable with a closure and a foil layer disposed therebetween, the liner defining at least one vent; and
the closure including a seal engageable with the backing layer, the seal defining at least one relief.

13. A blow molded packaging container as recited in claim 12, wherein the at least one vent includes a conical shaped cavity extending through the plurality of layers in communication with the volume, the at least one vent and the at least one relief are configured for passage of a pressurized gas from an interior volume of the container to an exterior environment of the container.

14. (canceled)

15. A blow molded packaging container as recited in claim 12, wherein the seal of the closure is disposed in a circumferential orientation about an inner wall surface of the closure.

16. A packaging container as recited in claim 12, wherein the at least one vent includes a plurality of vents aligned in a linear orientation.

17. A packaging container as recited in claim 12, wherein the seal of the closure is disposed in a circumferential orientation about an inner wall surface of the closure and the at least one vent is 10% or less of the circumference.

18. A method for manufacturing a packaging container, the method comprising the steps of:
blow molding an article having a selected configuration and including a body defining a volume, a neck and a dome;
trimming the article to remove the dome to form a finished container;
attaching a liner to the neck to form a hermetic seal, the liner having a plurality of layers including at least a heat seal layer engageable with the neck and a backing layer engageable with a closure, the liner defining at least one opening; and
attaching the closure to the neck, the closure including a projection engageable with the backing layer, the projection defining at least one gap.

19. A method as recited in claim 18, wherein the plurality of layers further includes a foil layer disposed between the heat seal layer and the backing layer.

20. A method as recited in claim 18, wherein the at least one gap includes at least one relief.

21. A blow molded packaging container comprising:
a body defining a volume, the body including a base, and a neck extending from an opening of the body;
a liner engageable with the neck to form a hermetic seal, the liner having a plurality of layers including at least a heat seal layer engageable with the neck and a backing layer engageable with a closure, the liner defining at least one vent; and
the closure engageable with the liner.
